(19) United States
(12) Patent Application Publication
(10) Pub. No.: US 2016/0261875 A1
(43) Pub. Date: Sep. 8, 2016

(54) VIDEO STREAM PROCESSING METHOD AND VIDEO PROCESSING APPARATUS THEREOF

(71) Applicant: Ali Corporation, Hsinchu (TW)

(72) Inventor: Wen-Han Zheng, Guangdong (CN)

(21) Appl. No.: 14/819,914

(22) Filed: Aug. 6, 2015

(30) Foreign Application Priority Data
Mar. 6, 2015 (CN) 201510099881.1

(51) Int. Cl. H04N 19/176; H04N 19/503; H04N 19/96; H04N 19/124

(52) U.S. Cl. CPC H04N 19/176; H04N 19/124; H04N 19/503; H04N 19/96

(57) ABSTRACT

A video stream processing method and a video processing apparatus thereof are provided. The video stream processing method includes the following steps: obtaining a video stream, wherein the video stream is composed of a plurality of basic processing units; determining whether a size of the basic processing units is greater than a predetermined size; if the size of the basic processing units is greater than the predetermined size, determining whether each of the basic processing units has a coding-unit-splitting flag; splitting each of the basic processing units into a plurality of blocks according to the coding-unit-splitting flag or the type of each of the basic processing units, wherein a size of the blocks is equal to or less than the predetermined size; and, performing a video processing of the video stream according to the blocks.

### CROSS-REFERENCE TO RELATED APPLICATION

This application claims the priority benefit of China application serial no. 201510099881.1, filed on Mar. 6, 2015. The entirety of the above-mentioned patent application is hereby incorporated by reference herein and made a part of this specification.

### BACKGROUND OF THE INVENTION

1. Field of the Invention

The invention generally relates to a data flow processing technique, and more particularly to, a video stream processing method suitable for high-efficiency video coding (HEVC) and a video processing apparatus thereof.

2. Description of Related Art

With the advances in video stream technology, video compression standards are constantly updated. Currently, High-efficiency video coding (HEVC) is the newest video compression standard and is considered as a successor of advanced video coding (AVC) (also referred to as ITU-T H.264/MPEG-4). As compared to the AVC, the HEVC not only enhances the quality of the image but also increases an image compression rate to twice as the AVC's rate.

In the HEVC, basic coding units in each video stream are referred to as coding tree units (CTUs), and sizes of the CTUs that are capable of being supported by the HEVC may go from 64*64 pixels to 128*128 pixels. During a process of the video stream, a memory capacity required by each grade of video decoder in the equipment for processing the video stream will be determined directly based on the size of the CTU. That is to say, when performing the video processing, each grade of video decoder will temporarily store the required CTUs in a buffer. If the size of the CTUs is relatively small, then it requires a buffer with a small capacity to perform the processing of the video stream. In contrast, if the size of the CTUs is relatively large, then it requires a buffer with a large capacity to perform the processing of the video stream. Therefore, in order to decrease the required capacity of the buffer, it is generally desirable to reduce the size of the CTUs. However, if the size of the basic coding units is required to reduce additionally less than 64*64 pixels, for the purpose of saving the capacity of the buffer, it may need extra technique to complete the process of the video stream because of the minimum size of the CTU in the HEVC is 64*64 pixels currently.

### SUMMARY OF THE INVENTION

The invention is directed to a video stream processing method and a video processing apparatus using this video stream processing method, so as to split in advance a pixel size of a basic processing unit in a video stream into smaller pixel sizes, and thereby decreases a memory capacity required by the video processing apparatus and safes the cost.

The invention is directed to a video stream processing method including the following steps: obtaining a video stream, wherein the video stream is composed of a plurality of basic processing units; determining whether a size of the basic processing units is greater than a predetermined size; if the size of the basic processing units is greater than the predetermined size, determining whether each of the basic processing units has a coding-unit-splitting flag; splitting each of the basic processing units into a plurality of blocks according to the coding-unit-splitting flag or a type of each of the basic processing units, wherein a size of the blocks is equal to or smaller than the predetermined size; and, performing a video processing on the video stream according to the blocks.

In one embodiment of the invention, the step of splitting each of the basic processing units into the plurality of blocks according to the coding-unit-splitting flag includes the following step: when each of the basic processing units has the coding-unit-splitting flag, splitting each of the basic processing units into a plurality of quadtree coding units according to the coding-unit-splitting flag and using the quadtree coding units as the blocks, wherein a size of the quadtree coding units equals to the predetermined size.

In one embodiment of the invention, the step of splitting each of the basic processing units into the plurality of blocks according to a type of each of the basic processing units includes the following steps: determining whether each of the basic processing units has an intra-prediction flag or an inter-prediction flag, so as to perform a video stream analysis of intra prediction or inter prediction on each of the basic processing units; determining whether each of the basic processing units has a transform-unit-splitting flag after the intra prediction or the inter prediction; and, when each of the basic processing units has the transform-unit-splitting flag, splitting each of the basic processing units into a plurality of transform sub-units according to the transform-unit-splitting flag and using the transform sub-units as the blocks, wherein a size of the transform sub-units equals to the predetermined size.

In one embodiment of the invention, video stream processing method further includes the following step: when each of the basic processing units does not have the intra-prediction flag or the inter-prediction flag, splitting each of the basic processing units into the blocks according to the predetermined size.

In one embodiment of the invention, video stream processing method further includes the following step: respectively calculating a quantization parameter corresponding to each of the blocks, wherein the quantization parameter is calculated according to a quantization parameter delta value in the video stream and a plurality of quantization parameter predictive values corresponding to the blocks that are adjacent to each of the blocks.

In one embodiment of the invention, the step of respectively calculating the quantization parameter corresponding to each of the blocks includes the following step: when each of the blocks is a first block, obtaining in advance in the video stream the quantization parameter predictive values corresponding to the blocks that come after each of the blocks, so as to calculate the quantization parameter of each of the blocks.

In one embodiment of the invention, the video stream complies with a high-efficiency video coding standard (HEVC standard). The basic processing units are a plurality of coding tree units. The size of the basic processing units is, for example, 64 pixels by 64 pixels, and the predetermined size is 32 pixels by 32 pixels or 16 pixels by 16 pixels.

From another point of view, the invention is directed to a video processing apparatus. The video processing apparatus includes an information analyzer and a first grade video decoder. The information analyzer obtains a video stream from an interface. The video stream is composed of a plurality of basic processing units. The first grade video decoder is coupled to the information analyzer. The first grade video decoder determines whether a size of the basic processing units is greater than a predetermined size. If the size of the basic processing units is greater than the predetermined size, the first grade video decoder determines whether each of the basic processing units has a coding-unit-splitting flag and splits each of the basic processing units into a plurality of blocks according to the coding-unit-splitting flag or the type of each of the basic processing units, wherein a size of the blocks is equal to the predetermined size.

Other details regarding the video processing apparatus of the invention can be referred to the above descriptions, and thus will not be repeated herein.

Accordingly, the video stream processing method and the video processing apparatus using this video stream processing method described in the embodiments of the invention use the information in the basic processing units (such as, the coding-unit-splitting flag, the transform-unit-splitting flag, the type of each of the basic processing units and so forth) to split the pixel size of the basic processing units in the video stream into the smaller pixel sizes. Hence, the video processing apparatus in the embodiment of the invention can have a smaller memory capacity in each grade of video decoder, and thereby saves the cost.

In order to make the aforementioned features and advantages of the present invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a video processing apparatus according to an embodiment of the invention.

FIG. 2 is a flow chart illustrating a video stream processing method according to an embodiment of the invention.

FIG. 3 is a schematic diagram illustrating how a basic processing unit is split into a plurality of blocks, as described in step S250 of FIG. 2.

FIG. 4 is a detailed flow chart illustrating the step S260 of FIG. 2.

FIG. 5 is a schematic diagram illustrating how a basic processing unit is split into a plurality of transform sub-units, as described in step S470 of FIG. 4.

### DESCRIPTION OF THE EMBODIMENTS

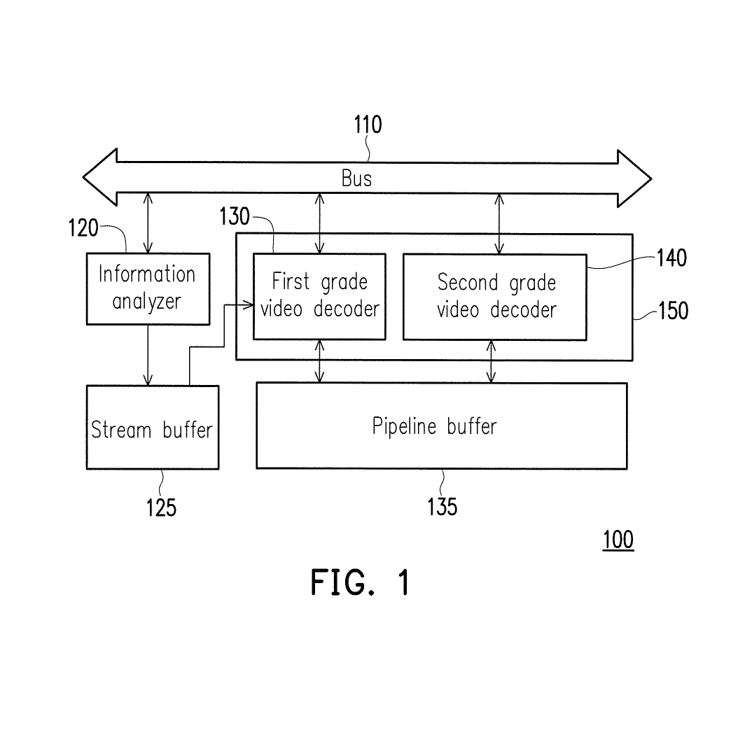

FIG. 1 is a schematic diagram illustrating a video processing apparatus 100 according to an embodiment of the invention. The video processing apparatus 100 mainly has an information analyzer 120 and a main decoder 150. In the present embodiment, the main decoder 150 includes a first grade video decoder 130 and a second grade video decoder 140. The second grade video decoder 140 may have many grades of video decoding processor therein according to different video decoding functions, such as having an inter picture decoder, an intra picture decoder, a de-blocking filter, a loop filter and so forth. In other words, the second grade video decoder 140 may be the Multi-grades video decoding processor. The processing functions of these video decoding processor may be different, but all can be used for processing the video stream.

In the present embodiment, the video processing apparatus 100 is configured to receive and decode a video stream complied with a high-efficiency video coding (HEVC) standard, so as to output a decoded video information. The video stream complied with the HEVC standard is composed of a plurality of basic processing units (namely, a plurality of coding tree units (CTU)). In other words, the video processing apparatus 100 of the present embodiment is mainly applied to a video stream composed of CTUs, so as to split each CTU in the video stream into a plurality of video units with smaller size (e.g., 32*32 pixels or 16*16 pixels). Herein, the video units with smaller sizes are referred to as the blocks. In the present embodiment, a predetermined size is, for example, set as 32*32 pixels, and those who apply the present embodiment can arbitrarily adjust the predetermined size based on the design requirements, such as setting the predetermined size to be 16*16 pixels. However, it is to be noted that, the smaller the predetermined size is being adjusted to, the greater the computational complexity in transforming each of the basic processing units in the video stream into the blocks of the predetermined size. Also, as restricted by other decoding requirements, such as decoding window restrictions, the predetermined size cannot be limitlessly set to a minimum value supported by the decoding standard; it has to be determined based on the actual situation.

The information analyzer 120 of the video processing apparatus 100 obtains the video stream complied with the HEVC standard through a transmission interface, such as a bus 110 or so forth. In the present embodiment, the information analyzer 120 can be an entropy parser. In detail, the information analyzer 120 can perform different operations according to the CTUs of the video stream transmitted by the bus 110, and the information analyzer 120 can temporarily store the CTU which being marked as an intra picture (also referred to as I picture frame) in a stream buffer 125, so as to enable the main decoder 150 to perform a HEVC video stream decoding process according to the video information in an I stream.

It is to be explained that, for general video processing apparatus 100 complied with the HEVC standard, each grade of video decoder in the main decoder 150 would perform the HEVC video stream decoding process according to a predetermined size in each of the CTUs of the video stream, so that the stream buffer 125 and the pipeline buffer 135 can buffer the video stream according to the predetermined sizes of the CTUs. However, since a regulation of the minimum size of the CTUs in the HEVC standard is already set to 64*64 pixels, if it is to further reduce the size of the CTUs of the video stream for saving the buffer capacity, then it would require a special approach to split the CTUs into even smaller units, which are to be used as decoding blocks.

As such, in the embodiment of the invention, the main decoder 150 firstly analyzes the information (e.g., a coding-unit-splitting flag, a transform-unit-splitting flag, the type of each of the basic processing units, etc) in the basic processing units (namely, CTUs) by using the signal analyzer 120, and then splits the pixel size of the basic processing units in the video stream into blocks having smaller pixel sizes (e.g., 32*32 pixels or 16*16 pixels) by using the first grade video decoder 130 in the main decoder 150, so that the second grade video decoder 140 can perform the video stream processing according to the splitted blocks. It can be known from experiments that, in the present embodiment, when using CTUs with 64*64 pixel size as the basic processing units of the video stream, the pipeline buffer 135 may be required to have a capacity of 12288 bytes; however, when using CTUs with 32*32 pixel size as the basic processing units of the video stream, the pipeline buffer 135 may only be required to have a capacity of 3072 bytes. As such, the embodiment of the invention can achieve an effect of saving a memory capacity required by the video processing apparatus 100, and thereby saves the implementation cost for the video processing apparatus 100. The capacity of the pipeline buffer 135 has a positive correlation relationship with the pixel size of the basic processing units in the video stream, and those who apply the present embodiment would know that, the above contents are merely provided as examples and are not intended for limiting the invention. In the following, several embodiments complied with the concepts of the invention are described in details for disclosing the present invention.

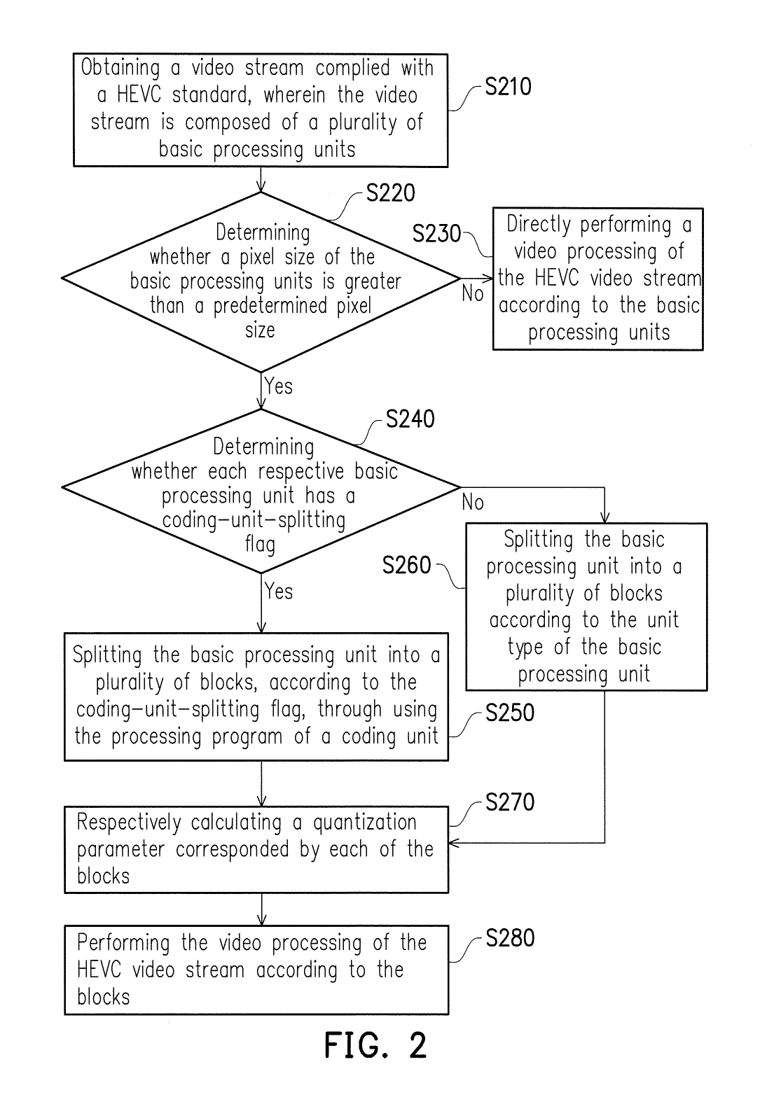

FIG. 2 is a flow chart illustrating a video stream processing method according to an embodiment of the invention. The present embodiment, for example, adopts the video processing apparatus 100 in FIG. 1 to realize the video stream processing method. Referring to FIG. 1 and FIG. 2 at the same time, in step S210, the information analyzer 120 in the video processing apparatus 100 can obtain the video stream complied with the HEVC standard from the bus 110. The video stream is composed of the plurality of basic processing units (namely, the coding tree units (CTU)). In step S220, the first grade video decoder 130 determines whether a pixel size of the basic processing units is greater than a predetermined pixel size. In the present embodiment, the pixel size of the basic processing units is generally 64*64 pixels, and the predetermined pixel size is 32*32 pixels or 16*16 pixels.

When the first grade video decoder 130 determines that the pixel size of the basic processing units is smaller or equal to the predetermined pixel size, it indicates that the pixel size of the basic processing units is relatively small, and each grade of buffer in the video processing apparatus 100 should be sufficient for use. Therefore, in step 230, the second grade video decoder 140 can directly perform the video processing of the HEVC video stream according to the basic processing units. However, the pixel size of the CTUs is generally greater than the predetermined pixel size; thus, in step S240, the first grade video decoder 130 determines whether each respective basic processing unit has a coding-unit-splitting flag (marked as CU_SPLIT_FLAG). If the basic processing unit has the coding-unit-splitting flag CU_SPLIT_FLAG, or the coding-unit-splitting flag CU_SPLIT_FLAG of the basic processing unit is “1”, then in step S250, by using the processing program of a coding unit, the first grade video decoder 130 splits the basic processing unit into a plurality of blocks according to the coding-unit-splitting flag. If the basic processing unit does not have the coding-unit-splitting flag, or the coding-unit-splitting flag CU_SPLIT_FLAG of the basic processing unit is “0”, then in step S260, the first grade video decoder 130 splits the basic processing unit into a plurality of blocks according to the type of the basic processing unit. Detail process flows of step S250 and step S260 can be referred to the following disclosures.

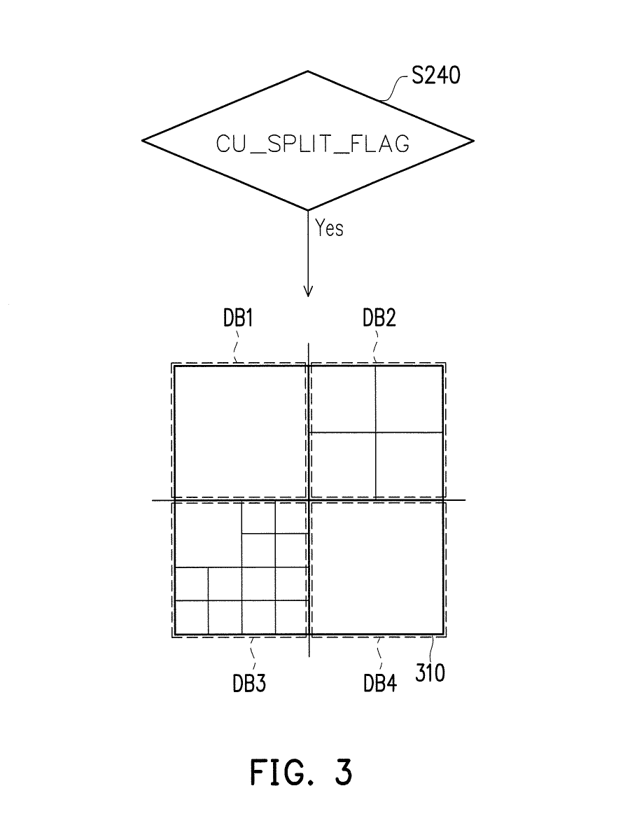

Herein, a schematic diagram illustrated in FIG. 3 is further provided to elaborate on the step S250 of FIG. 2. FIG. 3 is the schematic diagram illustrating how each of the basic processing units is split into a plurality of blocks, as described in step S250. As shown in FIG. 3, when the basic processing unit has the coding-unit-splitting flag CU_SPLIT_FLAG, the CTU 310 with 64*64 pixel size can be split into four quadtree coding units with 32*32 pixel size according to the content in the coding-unit-splitting flag CU_SPLIT_FLAG, so as to be used as the blocks DB1 to DB4. The size of the quadtree coding units (the blocks DB1 to DB4) equals to the predetermined size (e.g., 32*32 pixels). In the present embodiment, each of the quadtree coding units (the blocks DB1 to DB4) may possibly be further divided into even smaller quadtree coding units (coding quadtree units) due to the HEVC, but the present embodiment merely split the CTU 310 into the blocks DB1 to DB4, such that other processing program related to the quadtree coding units would be reserved for the subsequent second grade video decoder 140, so as to perform the processing of the HEVC video stream.

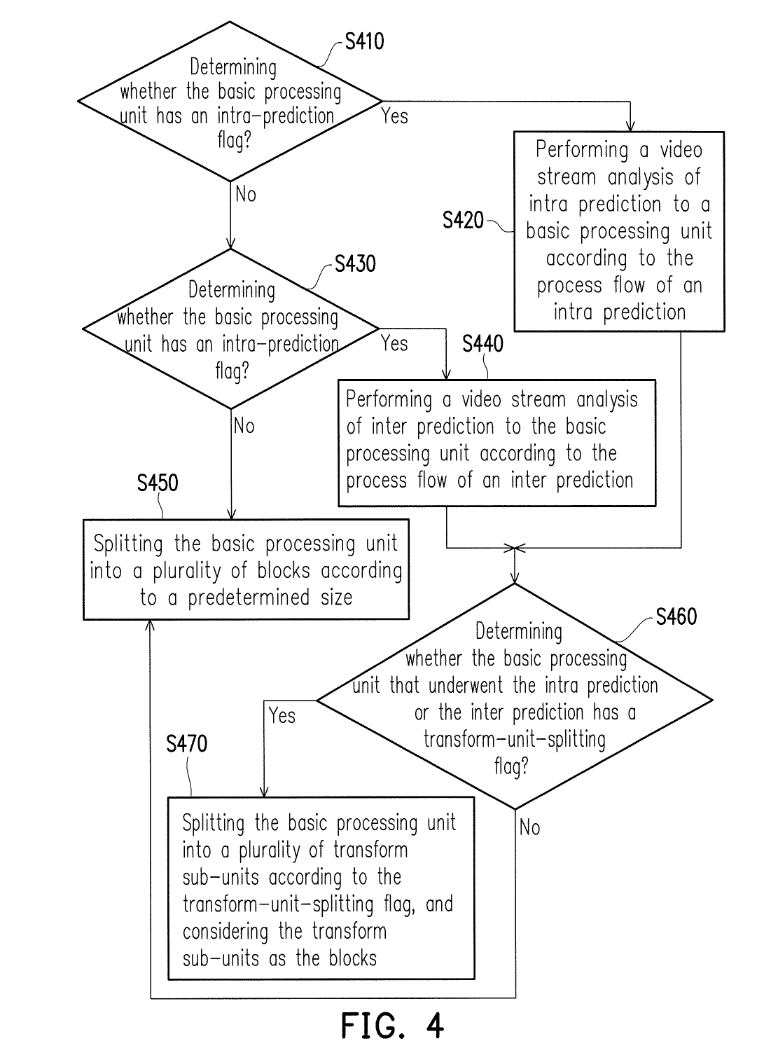

FIG. 4 is provided to describe the process in step S260 of FIG. 2 in details. FIG. 4 is a detailed flow chart illustrating the step S260 of FIG. 2. The CTUs, in addition to being marked as intra pictures (I picture frames), may also be classified into predicted pictures (P picture frames) and Bi-predictive pictures (B picture frames) according to an intra-prediction flag (which can be marked as Pred_mode_FLAG) or an inter-prediction flag (which can be marked as Pcm_mode_FLAG). When the CTUs are being classified as the predicted pictures or the Bi-predictive pictures, the video information in the CTUs are mainly pixel differences between the video blocks and motion vectors which underwent a motion compensation coding process. Referring to FIG. 1 and FIG. 4 at the same time, when enters into the step S260 of FIG. 2, firstly in step S410, the first grade video decoder 130 determines whether the basic processing unit that is being processed has the intra-prediction flag Pred_mode_FLAG. If the basic processing unit that is being processed has the intra-prediction flag Pred_mode_FLAG, then in step S420, the first grade video decoder 130 performs a video stream analysis of intra prediction to the basic processing unit according to the process flow of the intra prediction, so as to produce the intra prediction blocks (pixels with a size of 64*64). If the basic processing unit that is being processed does not have the inter-prediction flag Pcm_mode_FLAG, then in step S430, the first grade video decoder 130 determines whether the basic processing unit that is being processed has the inter-prediction flag Pcm_mode_FLAG. If the basic processing unit that is being processed has the inter-prediction flag Pcm_mode_FLAG, then in step S440, a video stream analysis of inter prediction is performed to the basic processing unit according to the process flow of the inter prediction, so as to produce the inter prediction blocks (pixels with the size of 64*64). If the basic processing unit that is being processed has neither the intra-prediction flag Pred_mode_FLAG nor the inter-prediction flag Pcm_mode_FLAG, then in step S450, the first grade video decoder 130 split the basic processing unit that is being processed into a plurality of blocks according to the predetermined size (32*32 pixels). Moreover, when the step S420 or the step S440 is completed, in step S460, the first grade video decoder 130 determines whether the basic processing unit that underwent the intra prediction or the inter prediction has a transform-unit-splitting flag (can be marked as TU_SPLIT_FLAG). When the basic processing unit has the transform-unit-splitting flag TU_SPLIT_FLAG, or when the transform-unit-splitting flag TU_SPLIT_FLAG of the basic processing unit is “1”, then in step S470, the first grade video decoder 130 split the basic processing unit into a plurality of transform sub-units according to the transform-unit-splitting flag TU_SPLIT_FLAG and a transform unit processing program in the HEVC protocol, and considers the transform sub-units as the blocks, wherein a size of the transform sub-units is equal to the predetermined size (32*32 pixels). Relatively, when the basic processing unit does not have the transform-unit-splitting flag TU_SPLIT_FLAG, or when the transform-unit-splitting flag TU_SPLIT_FLAG of the basic processing unit is “0”, then in step S450, the first grade video decoder 130 splits the basic processing unit that is being processed into a plurality of blocks according to the predetermined size (32*32 pixels).

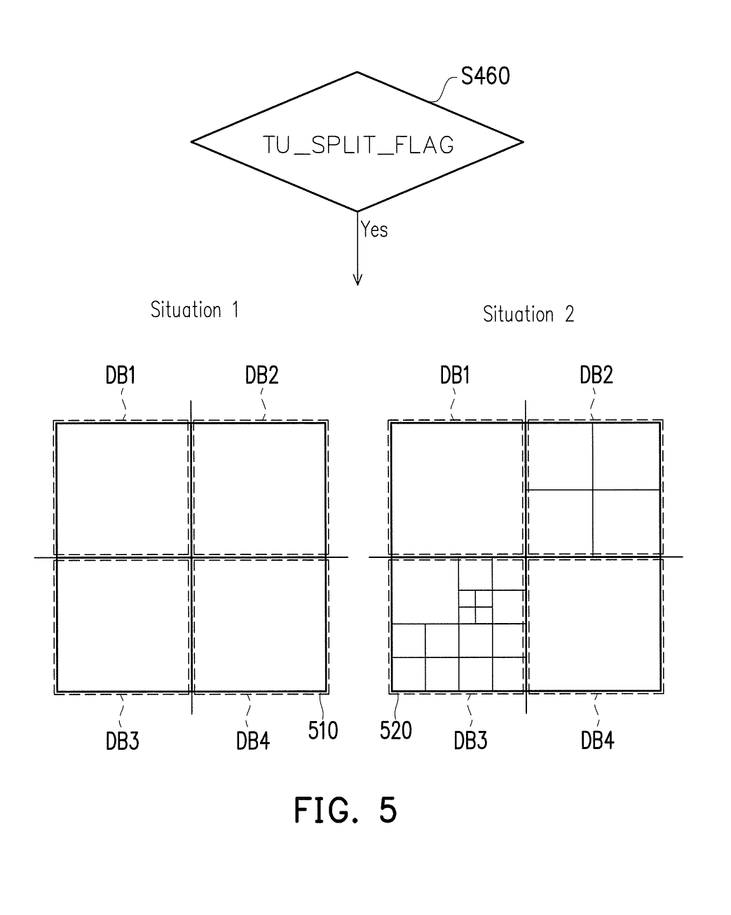

A schematic diagram is illustrated in FIG. 5 to describe the step S4701 of FIG. 4 in further details. FIG. 5 is the schematic diagram illustrating how each of the basic processing units is split into a plurality of transform sub-units, as described in step S470. As shown in FIG. 5, when the basic processing unit has the transform-unit-splitting flag TU_SPLIT_FLAG, the CTU 510 with 64*64 pixel size may be split into four transform sub-units with 32*32 pixel size based on the content in the transform-unit-splitting flag TU_SPLIT_FLAG, so as to be used as the blocks DB1 to DB4. The transform-unit-splitting flag TU_SPLIT_FLAG may be used to indicate how many layers of transform sub-units can be split from the CTU, which is being used as the transform unit. In a situation 1 shown in FIG. 5, because the transform-unit-splitting flag TU_SPLIT_FLAG indicates that the CTU 510 being split for once, and produce 4 blocks DB1 to DB4 accordingly. In a situation 2 shown in FIG. 5, because the transform-unit-splitting flag TU_SPLIT_FLAG indicates that the CTU 520 being split for several times, the blocks DB2 and DB3 have a plurality of transform sub-units that are sub-divided therein. In the embodiment of the invention, no matter it is in the situation 1 or the situation 2, the CTUs 510 and 520 are only being split into blocks DB1 to DB4 that are complied with the predetermined size, and will not be sub-divided any further. The video processing program for further sub-division will be realized by the subsequent second grade video decoder 140 shown in FIG. 1, but not by the first grade video decoder 130.

Referring back to FIG. 2 and FIG. 1 at the same time, after executing the step S250 and the step S260, the basic processing units are all split into the blocks of predetermined size; however, each of the basic processing units in the original HEVC would be accompanied by a corresponding quantization parameter to undergo a picture prediction or a video stream process. Hence, in order to allow each of the blocks to have the corresponding quantization parameter, in step S270, the first grade video decoder 130 respectively calculates the quantization parameter corresponded by each of the blocks. The quantization parameter is calculated according to a quantization parameter delta value (can be marked as QP_Delta_value) in the video stream and a plurality of quantization parameter predictive values corresponding to the blocks that are adjacent to each of the blocks. In addition, when the first grade video decoder 130 is calculating, for example, the block DB1 as shown in FIG. 3 or FIG. 5, it reads from the video stream the quantization parameter predictive values corresponding to the blocks (e.g., the blocks DB2 to DB4) that come after the block DB1, so as to calculate the quantization parameter of the block DB1. In step S280, the second grade video decoder 140 of FIG. 1 performs the video processing of the HEVC video stream according to the blocks.

In view of the above, the video stream processing method and the video processing apparatus using this video stream processing method described in the embodiments of the invention use the information in the basic processing units (such as, the coding-unit-splitting flag, the transform-unit-splitting flag, the type of each of the basic processing units and so forth) to split the pixel size of the basic processing units in the video stream into the smaller pixel sizes. As such, the video processing apparatus in the embodiment of the invention can have the smaller memory capacity in each grade of video decoder, and thereby saves the cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video stream processing method, comprising:
obtaining a video stream complied with a high-efficiency video coding standard, wherein the video stream is composed of a plurality of basic processing units;
determining whether a size of the basic processing units is greater than a predetermined size;
if the size of the basic processing units is greater than the predetermined size, determining whether each of the basic processing units has a coding-unit-splitting flag;
splitting each of the basic processing units into a plurality of blocks according to the coding-unit-splitting flag or a type of each of the basic processing units, wherein a size of the blocks is equal to or smaller than the predetermined size; and
performing a video processing of the video stream according to the blocks.

2. The video stream processing method as recited in claim 1, wherein the step of splitting each of the basic processing units into the plurality of blocks according to the coding-unit-splitting flag comprises the following step:
when each of the basic processing units has the coding-unit-splitting flag, splitting each of the basic processing units into a plurality of quadtree coding units according to the coding-unit-splitting flag and using the quadtree coding units as the blocks, wherein a size of the quadtree coding units equals to the predetermined size.

3. The video stream processing method as recited in claim 1, wherein the step of splitting each of the basic processing units into the plurality of blocks according to the type of each of the basic processing units comprises the following steps:
determining whether each of the basic processing units has an intra-prediction flag or an inter-prediction flag, so as to perform a video stream analysis of intra prediction or inter prediction on each of the basic processing units;
determining whether each of the basic processing units has a transform-unit-splitting flag after the intra prediction or the inter prediction; and
when each of the basic processing units has the transform-unit-splitting flag, splitting each of the basic processing units into a plurality of transform sub-units according to the transform-unit-splitting flag and using the transform sub-units as the blocks, wherein a size of the transform sub-units equals to the predetermined size.

4. The video stream processing method as recited in claim 3, further comprising the following step:
when each of the basic processing units does not have the intra-prediction flag or the inter-prediction flag, splitting each of the basic processing units into the blocks according to the predetermined size.

5. The video stream processing method as recited in claim 1, further comprising the following step:
respectively calculating a quantization parameter corresponding to each of the blocks, wherein the quantization parameter is calculated according to a quantization parameter delta value in the video stream and a plurality of quantization parameter predictive values corresponding to the blocks that are adjacent to each of the blocks.

6. The video stream processing method as recited in claim 5, wherein the step of respectively calculating the quantization parameter corresponding to each of the blocks comprises the following step:
when each of the blocks is a first block, obtaining in advance in the video stream the quantization parameter predictive values corresponding to the blocks that come after each of the blocks, so as to calculate the quantization parameter of each of the blocks.

7. The video stream processing method as recited in claim 1, wherein the basic processing units are a plurality of coding tree units, the size of the basic processing units is 64 pixels by 64 pixels, and the predetermined size is 32 pixels by 32 pixels or 16 pixels by 16 pixels.

8. A video processing apparatus, comprising:
an information analyzer, obtaining a video stream complied with a high-efficiency video coding standard from an interface, wherein the video stream is composed of a plurality of basic processing units; and
a first grade video decoder, coupled to the information analyzer and determining whether a size of the basic processing units is greater than a predetermined size, wherein if the size of the basic processing units is greater than the predetermined size, the first grade video decoder determines whether each of the basic processing units has a coding-unit-splitting flag, and splits each of the basic processing units into a plurality of blocks according to the coding-unit-splitting flag or a type of each of the basic processing units, wherein a size of the blocks is equal to or less than the predetermined size.

9. The video stream processing method as recited in claim 8, further comprising:
a second grade video decoder, coupled to the first grade video decoder and performing a video processing to the video stream according to the blocks.

10. The video stream processing method as recited in claim 8, wherein when each of the basic processing units has the coding-unit-splitting flag, the first grade video decoder splits each of the basic processing units into a plurality of quadtree coding units according to the coding-unit-splitting flag and uses the quadtree coding units as the blocks, wherein a size of the quadtree coding unit is equal to the predetermined size.

11. The video stream processing method as recited in claim 8, wherein the first grade video decoder determines whether each of the basic processing units has an intra-prediction flag or an inter-prediction flag, so as to perform a video stream analysis of intra prediction or inter prediction on each of the basic processing units,
the first grade video decoder determines whether each of the basic processing units has a transform-unit-splitting flag after the intra prediction or inter prediction, and
when each of the basic processing units has the transform-unit-splitting flag, the first grade video decoder splits each of the basic processing units into a plurality of transform sub-units according to the transform-unit-splitting flag and uses the transform sub-units as the blocks, wherein a size of the transform sub-units equals to the predetermined size.

12. The video stream processing method as recited in claim 11, wherein when each of the basic processing units does not have the intra-prediction flag or the inter-prediction flag, the first grade video decoder splits each of the basic processing units into the blocks according to the predetermined size.

13. The video stream processing method as recited in claim 8, wherein the first grade video decoder respectively calculates a quantization parameter corresponding to each of the blocks, wherein the quantization parameter is calculated according to a quantization parameter delta value in the video stream and a plurality of quantization parameter predictive values corresponding to the blocks that are adjacent to each of the blocks.

14. The video stream processing method as recited in claim 8, wherein the video stream is complied with the high-efficiency video coding standard, the basic processing units are a plurality of coding tree units, the size of the basic processing units is 64 pixels by 64 pixels, and the predetermined size is 32 pixels by 32 pixels or 16 pixels by 16 pixels.
